(19) United States
(12) Patent Application Publication
(10) Pub. No.: US 2017/0173674 A1
(43) Pub. Date: Jun. 22, 2017

(54) MOLD ASSEMBLY INCLUDING A DEOXYGENATED CORE AND METHOD OF MAKING SAME

(71) Applicant: General Electric Company, Schenectady, NY (US)

(72) Inventors: Michael Douglas Arnett, Simpsonville, SC (US); Joseph Leonard Moroso, Greenville, SC (US); Thomas Michael Moors, Simpsonville, SC (US)

(21) Appl. No.: 14/972,645

(22) Filed: Dec. 17, 2015

(51) Int. Cl. B22C 9/10; B22C 9/12; F01D 25/12; B22C 9/02; F01D 9/04; F01D 5/18; B22C 1/00; B22C 9/24

(52) U.S. Cl. CPC B22C 9/108; B22C 1/00; B22C 9/12; B22C 9/24; B22C 9/02; F01D 9/041; F01D 5/187; F01D 25/12; F05D 2220/32; F05D 2300/174; F05D 2300/171; F05D 2300/175; F05D 2230/21; F05D 2240/12; F05D 2240/30

(57) ABSTRACT

A mold assembly for use in forming a component having an internal passage defined therein includes a mold defining a mold cavity therein, and a deoxygenated core positioned with respect to the mold. The deoxygenated core includes an inner wall that at least partially defines a sealed core chamber within the deoxygenated core. The sealed core chamber has a substantially reduced oxygen content, and a portion of the deoxygenated core is positioned within the mold cavity such that the inner wall of the portion of the deoxygenated core defines the internal passage when the component is formed in the mold assembly.

### BACKGROUND

The field of the disclosure relates generally to components having an internal passage defined therein, and more particularly to forming such components using a hollow core.

Some components require an internal passage to be defined therein, for example, in order to perform an intended function. For example, but not by way of limitation, some components, such as hot gas path components of gas turbines, are subjected to high temperatures. At least some such components have internal passages defined therein to receive a flow of a cooling fluid, such that the components are better able to withstand the high temperatures. For another example, but not by way of limitation, some components are subjected to friction at an interface with another component. At least some such components have internal passages defined therein to receive a flow of a lubricant to facilitate reducing the friction.

At least some known components having an internal passage defined therein are formed in a mold, with a core of ceramic material extending within the mold cavity at a location selected for the internal passage. After a molten metal alloy is introduced into the mold cavity around the ceramic core and cooled to form the component, the ceramic core is removed, such as by chemical leaching, to form the internal passage. However, at least some known ceramic cores are fragile, resulting in cores that are difficult and expensive to produce and handle without damage. In addition, some molds used to form such components are formed by investment casting. However, at least some known ceramic cores lack sufficient strength to reliably withstand injection of a material, such as, but not limited to, wax, used to form a pattern for the investment casting process. In addition, the firing process used to harden an investment-cast mold tends to accelerate an oxidation of any metallic components associated with the mold and core assembly, negatively impacting a subsequent performance of the oxidized surface in some applications. Moreover, effective removal of at least some ceramic cores from the cast component is difficult and time-consuming, particularly for, but not limited to, components for which as a ratio of length-to-diameter of the core is large and/or the core is substantially nonlinear.

Alternatively or additionally, at least some known components having an internal passage defined therein are initially formed without the internal passage, and the internal passage is formed in a subsequent process. For example, at least some known internal passages are formed by drilling the passage into the component, such as, but not limited to, using an electrochemical drilling process. However, at least some such drilling processes are relatively time-consuming and expensive. Moreover, at least some such drilling processes cannot produce an internal passage curvature required for certain component designs.

### BRIEF DESCRIPTION

In one aspect, a mold assembly for use in forming a component having an internal passage defined therein is provided. The mold assembly includes a mold defining a mold cavity therein, and a deoxygenated core positioned with respect to the mold. The deoxygenated core includes an inner wall that at least partially defines a sealed core chamber within the deoxygenated core. The sealed core chamber has a substantially reduced oxygen content, and a portion of the deoxygenated core is positioned within the mold cavity such that the inner wall of the portion of the deoxygenated core defines the internal passage when the component is formed in the mold assembly.

In another aspect, a method of making a mold assembly for forming a component having an internal passage defined therein is provided. The method includes positioning a deoxygenated core with respect to a mold. The deoxygenated core includes an inner wall that at least partially defines a sealed core chamber within the deoxygenated core. A portion of the deoxygenated core is positioned within a cavity of the mold such that the inner wall of the portion of the deoxygenated core defines the internal passage when the component is formed in the mold assembly. The method also includes firing the mold having the deoxygenated core positioned with respect thereto. The sealed core chamber has a substantially reduced oxygen content such that oxidation of the inner wall is inhibited.

### DRAWINGS

FIG. 1 is a schematic diagram of an exemplary rotary machine;

FIG. 2 is a schematic perspective view of an exemplary component for use with the rotary machine shown in FIG. 1;

FIG. 3 is a schematic perspective view of an exemplary mold assembly for making the component shown in FIG. 2, the mold assembly including a deoxygenated core positioned with respect to a mold;

FIG. 4 is a schematic cross-section of the exemplary deoxygenated core for use with the mold assembly shown in FIG. 3, taken along lines 4-4 shown in FIG. 3;

FIG. 5 is a schematic cross-section of an exemplary hollow structure at a first stage during a first exemplary process of forming the deoxygenated core shown in FIG. 3;

FIG. 6 is a schematic cross-section of the exemplary hollow structure of FIG. 5 at a second stage during the first exemplary process of forming the deoxygenated core shown in FIG. 3;

FIG. 7 is a schematic cross-section of an exemplary hollow structure at a first stage during a second exemplary process of forming the deoxygenated core shown in FIG. 3;

FIG. 8 is a schematic cross-section of the exemplary hollow structure of FIG. 7 at a second stage during the second exemplary process of forming the deoxygenated core shown in FIG. 3;

FIG. 9 is a flow diagram of an exemplary method of forming a component having an internal passage defined therein, such as the component shown in FIG. 2; and

FIG. 10 is a continuation of the flow diagram of FIG. 9.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” is not to be limited to the precise value specified. In at least some instances, the approximating language may correspond to the precision of an instrument for measuring the value. Here and throughout the specification and claims, range limitations may be identified. Such ranges may be combined and/or interchanged, and include all the sub-ranges contained therein unless context or language indicates otherwise.

The exemplary assembly and methods described herein overcome at least some of the disadvantages associated with known assemblies and methods for forming a component having an internal passage defined therein. The embodiments described herein provide a deoxygenated core positioned with respect to a mold. The deoxygenated core includes an inner wall that defines the internal passage when the component is formed in the mold assembly. To inhibit oxidation of the inner wall during firing of the mold assembly, the core is sealed, and a core chamber defined by the inner wall has a substantially reduced oxygen content. For example, in some embodiments, the substantially reduced oxygen content is achieved by filling the core chamber with an inert gas. For another example, in certain embodiments, the substantially reduced oxygen content is achieved by at least partially evacuating the core chamber.

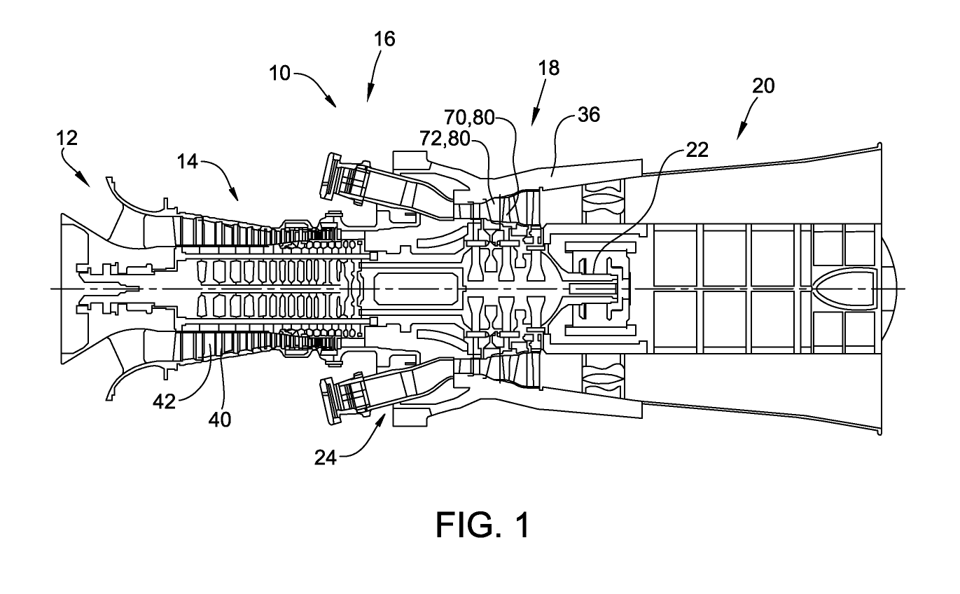

FIG. 1 is a schematic view of an exemplary rotary machine 10 having components for which embodiments of the current disclosure may be used. In the exemplary embodiment, rotary machine 10 is a gas turbine that includes an intake section 12, a compressor section 14 coupled downstream from intake section 12, a combustor section 16 coupled downstream from compressor section 14, a turbine section 18 coupled downstream from combustor section 16, and an exhaust section 20 coupled downstream from turbine section 18. A generally tubular casing 36 at least partially encloses one or more of intake section 12, compressor section 14, combustor section 16, turbine section 18, and exhaust section 20. In alternative embodiments, rotary machine 10 is any rotary machine for which components formed with internal passages as described herein are suitable. Moreover, although embodiments of the present disclosure are described in the context of a rotary machine for purposes of illustration, it should be understood that the embodiments described herein are applicable in any context that involves a component suitably formed with an internal passage defined therein.

In the exemplary embodiment, turbine section 18 is coupled to compressor section 14 via a rotor shaft 22. It should be noted that, as used herein, the term “couple” is not limited to a direct mechanical, electrical, and/or communication connection between components, but may also include an indirect mechanical, electrical, and/or communication connection between multiple components.

During operation of rotary machine 10, intake section 12 channels air towards compressor section 14. Compressor section 14 compresses the air to a higher pressure and temperature. More specifically, rotor shaft 22 imparts rotational energy to at least one circumferential row of compressor blades 40 coupled to rotor shaft 22 within compressor section 14. In the exemplary embodiment, each row of compressor blades 40 is preceded by a circumferential row of compressor stator vanes 42 extending radially inward from casing 36 that direct the air flow into compressor blades 40. The rotational energy of compressor blades 40 increases a pressure and temperature of the air. Compressor section 14 discharges the compressed air towards combustor section 16.

In combustor section 16, the compressed air is mixed with fuel and ignited to generate combustion gases that are channeled towards turbine section 18. More specifically, combustor section 16 includes at least one combustor 24, in which a fuel, for example, natural gas and/or fuel oil, is injected into the air flow, and the fuel-air mixture is ignited to generate high temperature combustion gases that are channeled towards turbine section 18.

Turbine section 18 converts the thermal energy from the combustion gas stream to mechanical rotational energy. More specifically, the combustion gases impart rotational energy to at least one circumferential row of rotor blades 70 coupled to rotor shaft 22 within turbine section 18. In the exemplary embodiment, each row of rotor blades 70 is preceded by a circumferential row of turbine stator vanes 72 extending radially inward from casing 36 that direct the combustion gases into rotor blades 70. Rotor shaft 22 may be coupled to a load (not shown) such as, but not limited to, an electrical generator and/or a mechanical drive application. The exhausted combustion gases flow downstream from turbine section 18 into exhaust section 20. Components of rotary machine 10 are designated as components 80. Components 80 proximate a path of the combustion gases are subjected to high temperatures during operation of rotary machine 10. Additionally or alternatively, components 80 include any component suitably formed with an internal passage defined therein.

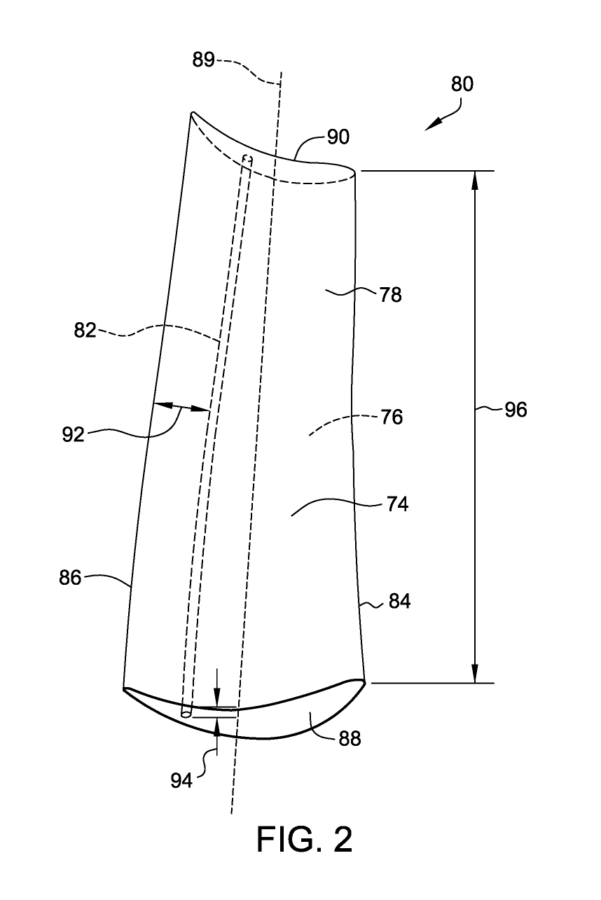

FIG. 2 is a schematic perspective view of an exemplary component 80, illustrated for use with rotary machine 10 (shown in FIG. 1). Component 80 includes at least one internal passage 82 defined therein. For example, a cooling fluid is provided to internal passage 82 during operation of rotary machine 10 to facilitate maintaining component 80 below a temperature of the hot combustion gases. Although only one internal passage 82 is illustrated, it should be understood that component 80 includes any suitable number of internal passages 82 formed as described herein.

Component 80 is formed from a component material 78. In the exemplary embodiment, component material 78 is a suitable nickel-based superalloy. In alternative embodiments, component material 78 is at least one of a cobalt-based superalloy, an iron-based alloy, and a titanium-based alloy. In other alternative embodiments, component material 78 is any suitable material that enables component 80 to be formed as described herein.

In the exemplary embodiment, component 80 is one of rotor blades 70 or stator vanes 72. In alternative embodiments, component 80 is another suitable component of rotary machine 10 that is capable of being formed with an internal passage as described herein. In still other embodiments, component 80 is any component for any suitable application that is suitably formed with an internal passage defined therein.

In the exemplary embodiment, rotor blade 70, or alternatively stator vane 72, includes a pressure side 74 and an opposite suction side 76. Each of pressure side 74 and suction side 76 extends from a leading edge 84 to an opposite trailing edge 86. In addition, rotor blade 70, or alternatively stator vane 72, extends from a root end 88 to an opposite tip end 90, defining a blade length 96. In alternative embodiments, rotor blade 70, or alternatively stator vane 72, has any suitable configuration that is capable of being formed with an internal passage as described herein.

In certain embodiments, blade length 96 is at least about 25.4 centimeters (cm) (10 inches). Moreover, in some embodiments, blade length 96 is at least about 50.8 cm (20 inches). In particular embodiments, blade length 96 is in a range from about 61 cm (24 inches) to about 101.6 cm (40 inches). In alternative embodiments, blade length 96 is less than about 25.4 cm (10 inches). For example, in some embodiments, blade length 96 is in a range from about 2.54 cm (1 inch) to about 25.4 cm (10 inches). In other alternative embodiments, blade length 96 is greater than about 101.6 cm (40 inches).

In the exemplary embodiment, internal passage 82 extends from root end 88 to tip end 90. In alternative embodiments, internal passage 82 extends within component 80 in any suitable fashion, and to any suitable extent, that enables internal passage 82 to be formed as described herein. In certain embodiments, internal passage 82 is nonlinear. For example, component 80 is formed with a predefined twist along an axis 89 defined between root end 88 and tip end 90, and internal passage 82 has a curved shape complementary to the axial twist. In some embodiments, internal passage 82 is positioned at a substantially constant distance 94 from pressure side 74 along a length of internal passage 82. Alternatively or additionally, a chord of component 80 tapers between root end 88 and tip end 90, and internal passage 82 extends nonlinearly complementary to the taper, such that internal passage 82 is positioned at a substantially constant distance 92 from trailing edge 86 along the length of internal passage 82. In alternative embodiments, internal passage 82 has a nonlinear shape that is complementary to any suitable contour of component 80. In other alternative embodiments, internal passage 82 is nonlinear and other than complementary to a contour of component 80. In some embodiments, internal passage 82 having a nonlinear shape facilitates satisfying a preselected cooling criterion for component 80. In alternative embodiments, internal passage 82 extends linearly.

In some embodiments, internal passage 82 has a substantially circular cross-section. In alternative embodiments, internal passage 82 has a substantially ovoid cross-section. In other alternative embodiments, internal passage 82 has any suitably shaped cross-section that enables internal passage 82 to be formed as described herein. Moreover, in certain embodiments, the shape of the cross-section of internal passage 82 is substantially constant along a length of internal passage 82. In alternative embodiments, the shape of the cross-section of internal passage 82 varies along a length of internal passage 82 in any suitable fashion that enables internal passage 82 to be formed as described herein.

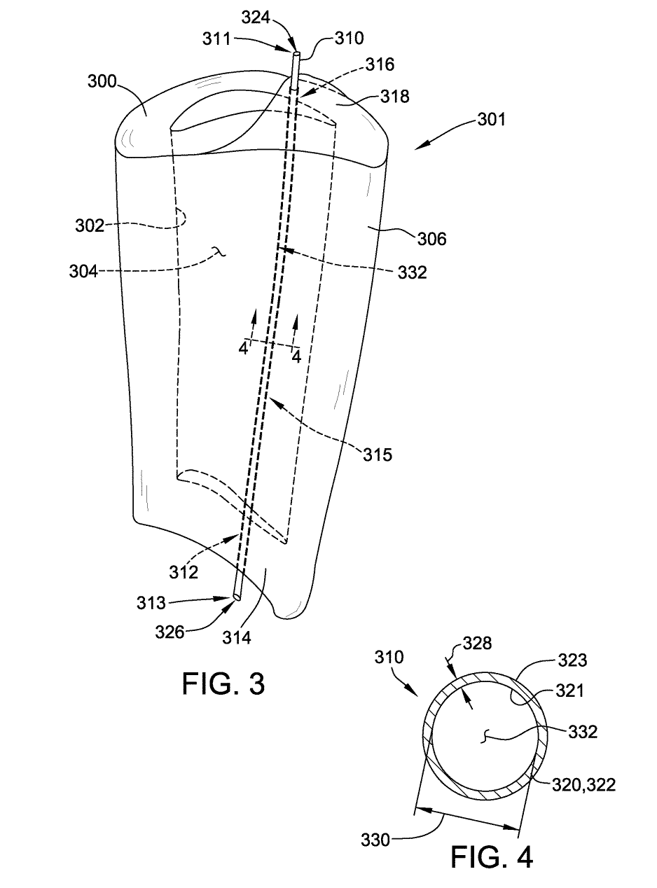

FIG. 3 is a schematic perspective view of a mold assembly 301 for making component 80 (shown in FIG. 2). Mold assembly 301 includes a deoxygenated core 310 positioned with respect to a mold 300. FIG. 4 is a schematic cross-section of deoxygenated core 310 taken along lines 4-4 shown in FIG. 3. With reference to FIGS. 2-4, an interior wall 302 of mold 300 defines a mold cavity 304. Interior wall 302 defines a shape corresponding to an exterior shape of component 80. It should be recalled that, although component 80 in the exemplary embodiment is rotor blade 70, or alternatively stator vane 72, in alternative embodiments component 80 is any component suitably formable with an internal passage defined therein, as described herein.

Deoxygenated core 310 includes a hollow structure 320 that extends from a first end 311 to an opposite second end 313. Hollow structure 320 is formed from a first material 322 and defines an inner wall 321 and an outer wall 323. Inner wall 321 defines a core chamber 332 within deoxygenated core 310. In addition, deoxygenated core 310 includes a first sealing plug 324 positioned in substantially sealing contact with hollow structure 320 proximate first end 311, and a second sealing plug 326 positioned in substantially sealing contact with hollow structure 320 proximate second end 313, such that first sealing plug 324 and second sealing plug 326 cooperate to substantially seal core chamber 332 within deoxygenated core 310.

In the illustrated embodiment, first end 311 is positioned proximate an open end of mold cavity 304, and second end 313 extends outwardly from mold 300 opposite first end 311. However, the designation of first end 311 and second end 313 is not intended to limit the disclosure. For example, in alternative embodiments, second end 313 is positioned proximate the open end of mold cavity 304, and first end 311 extends out of mold 300 opposite first end 311. Moreover, the illustrated positions of first end 311 and second end 313 are not intended to limit the disclosure. For example, in alternative embodiments, each of first end 311 and second end 313 is positioned proximate the open end of mold cavity 304, such that deoxygenated core 310 forms a U-shape within mold cavity 304. For another example, in other alternative embodiments, at least one of first end 311 and second end 313 is positioned within mold cavity 304. For another example, in other alternative embodiments, at least one of first end 311 and second end 313 is embedded within a wall of mold cavity 300. For another example, in other alternative embodiments, at least one of first end 311 and second end 313 extends outwardly from any suitable location on mold 300.

Deoxygenated core 310 is positioned with respect to mold 300 such that a portion 315 of deoxygenated core 310 extends within mold cavity 304. More specifically, deoxygenated core 310 is positioned with respect to mold 300 such that inner wall 321 of portion 315 of hollow structure 320 defines a selected position and shape of internal passage 82. For example, in certain embodiments, hollow structure 320 is pre-formed to correspond to a selected nonlinear shape of internal passage 82. In some such embodiments, hollow structure 320 is pre-formed to correspond to the nonlinear shape of internal passage 82 that is complementary to a contour of component 80. For example, but not by way of limitation, component 80 is one of rotor blade 70 and stator vane 72, and hollow structure 320 is pre-formed in a shape complementary to at least one of an axial twist and a taper of component 80, as described above.

In certain embodiments, hollow structure 320 defines a generally tubular shape. For example, but not by way of limitation, hollow structure 320 is initially formed from a substantially straight metal tube that is suitably manipulated into a nonlinear shape, such as a curved or angled shape, as necessary to define a selected nonlinear shape of internal passage 82. In alternative embodiments, hollow structure 320 defines any suitable shape that enables inner wall 321 to define a shape of internal passage 82 as described herein.

A shape of a cross-section of core chamber 332 along portion 315 of deoxygenated core 310 is selected to define a selected cross-sectional shape of internal passage 82 within component 80. The cross-sectional shape of core chamber 332 is circular in the exemplary embodiment shown in FIGS. 3 and 4. Alternatively, the shape of the cross-section of core chamber 332 corresponds to any suitable shape of the cross-section of internal passage 82 that enables internal passage 82 to function as described herein. A characteristic width 330 of core chamber 332 is defined herein as the diameter of a circle having the same cross-sectional area as core chamber 332. Moreover, in some embodiments, the shape of the cross-section of core chamber 332 varies along a length of hollow structure 320, to define a selected corresponding variation in the shape of the cross-section of internal passage 82 along its length. In alternative embodiments, the shape of the cross-section of core chamber 332 is substantially constant along a length of hollow structure 320.

Sealed core chamber 332 has a substantially reduced oxygen content relative to a similar volume of air at atmospheric pressure. The substantially reduced oxygen content in sealed core chamber 332 is sufficient to substantially inhibit oxidation of inner wall 321 during a process of firing mold assembly 301, as will be described herein. For example, in some embodiments, sealed core chamber 332 is filled with substantially an inert gas to substantially reduce the oxygen content. In some such embodiments, the inert gas is at least one of argon, nitrogen, and helium. For example, sealed core chamber 332 contains the inert gas having a residual oxygen content of less than or equal to about 100 parts per million (ppm). For another example, sealed core chamber 332 contains the inert gas having a residual oxygen content of less than or equal to about 50 parts per million (ppm).

As another example, sealed core chamber 332 is evacuated to at least a partial vacuum pressure to substantially reduce the oxygen content. For example, sealed core chamber 332 contains air at a vacuum pressure of less than or equal to about 0.076 torr. For another example, sealed core chamber 332 contains air at a vacuum pressure of less than or equal to about 0.00076 torr. For another example, sealed core chamber 332 contains air at a vacuum pressure of less than or equal to about 0.000076 torr.

In certain embodiments, both an inert gas and at least partial vacuum pressure cooperate to substantially reduce the oxygen content of sealed core chamber 332. For example, sealed core chamber 332 contains at a vacuum pressure, such as any of the vacuum pressure ranges described above, one of (i) an inert gas, such as described above, and (ii) a combination of an inert gas and air.

In alternative embodiments, the oxygen content of sealed core chamber 332 is reduced in any suitable fashion that enables deoxygenated core 310 to function as described herein.

In certain embodiments, component 80 is formed by adding component material 78 in a molten state to mold cavity 304 around deoxygenated core 310, such that hollow structure 320 proximate inner wall 321 remains intact. Component material 78 is cooled within mold cavity 304 to form component 80, such that inner wall 321 of portion 315 defines internal passage 82 within component 80.

First material 322 is selected such that hollow structure 320 embedded within component 80 does not prevent component 80 from meeting performance requirements associated with an intended function of component 80. As one example, component 80 is rotor blade 70, and first material 322 is selected to be compatible in proximity with component material 78 in an extreme operating environment of rotor blade 70.

Additionally, in some embodiments, first material 322 is selected to facilitate hollow structure 320 proximate inner wall 321 remaining intact after molten component material 78 is introduced into mold cavity 304 around deoxygenated core 310. More specifically, in some embodiments, first material 322 is selected to have a melting point greater than a casting temperature of component material 78. In alternative embodiments, first material 322 is selected to have any suitable melting point that enables hollow structure 320 to function as described herein.

In certain embodiments, component material 78 is at least one of a nickel-based superalloy and a cobalt-based superalloy, and molten component material 78 is maintained at a suitable casting temperature within a range of about 1300 C (2372 F) to about 1700 C (3092 F). In some such embodiments, first material 322 is a titanium-based material with a melting point of about 1168 C (3034 F). Alternatively, in some such embodiments, first material 322 is a niobium-based material with a melting point of about 2469 C (4476 F). Alternatively, in some such embodiments, first material 322 is a tantalum-based material with a melting point of about 3020 C (5468 F). In alternative embodiments, component material 78 is any suitable alloy having any suitable casting temperature, and first material 322 is at least one material that has a melting point greater than the casting temperature. Thus, when molten component material 78 is introduced into mold 300 and couples against an outer wall 323 of hollow structure 320 during casting of component 80, at least a portion of hollow structure 320 proximate inner wall 321 remains intact throughout the casting process. At least a portion of hollow structure 320 becomes embedded in component 80, such that inner wall 321 defines internal passage 82, when component material 78 is cooled to form component 80.

A wall thickness 328 of hollow structure 320 is defined between inner wall 321 and outer wall 323. In certain embodiments, during or after the introduction of molten component material 78 into mold cavity 304 to form component 80, a portion of hollow structure 320 adjacent outer wall 323 is absorbed into molten component material 78. In some embodiments, wall thickness 328 is selected to be sufficiently large such that a substantial portion of hollow structure 320 of portion 315 of deoxygenated core 310, that is, the portion that extends within mold cavity 304, remains intact and is embedded in component 80 after component material 78 in the molten state is introduced into mold cavity 304 and cooled to form component 80. For example, in some such embodiments, wall thickness 328 is substantially unchanged after component 80 is formed. In alternative embodiments, wall thickness 328 is selected to be relatively thin, such that a substantial portion of hollow structure 320 of portion 315 of deoxygenated core 310 is absorbed into molten component material 78 within mold cavity 304, and only a relatively thin portion of hollow structure 320 proximate inner wall 321 remains intact and is embedded in component 80.

In some embodiments, a use of deoxygenated core 310 rather than, for example, a substantially solid ceramic core (not shown), within mold assembly 301 to define internal passage 82 facilitates increased efficiency and reliability in forming component 80 having internal passage 82 defined therein. For example, deoxygenated core 310 pre-defines hollow core chamber 332 prior to casting component 80, such that no ceramic core need be removed after casting to complete formation of internal passage 82. Moreover, at least some ceramic cores are relatively brittle and, thus, subject to a relatively high risk of fracture, cracking, and/or other damage during initial forming, transport, injection of wax or other pattern material into a pattern die around the core, and/or pouring of molten component material 78 into mold cavity 304 surrounding the core. These risks are increased for at least some ceramic cores having large length-to-diameter (L/d) ratios and/or a high degree of nonlinearity. Deoxygenated core 310 is structurally robust as compared to such ceramic cores, and presents a much lower risk of damage during such processes as compared to using a ceramic core. Thus, deoxygenated core 310 facilitates obtaining advantages associated with positioning a ceramic core with respect to mold 300 to define internal passage 82, while reducing or eliminating fragility problems associated with a ceramic core. For example, deoxygenated core 310 facilitates formation of internal passage 82 having a curved and/or otherwise non-linear shape of increased complexity, and/or with a decreased time and cost, as compared to internal passages formed using ceramic cores.

Mold 300 is formed from a mold material 306. In the exemplary embodiment, mold material 306 is a refractory ceramic material selected to withstand a high temperature environment associated with the molten state of component material 78 used to form component 80. In alternative embodiments, mold material 306 is any suitable material that enables component 80 to be formed as described herein.

In the exemplary embodiment, mold 300 is formed by a suitable investment casting process. For example, but not by way of limitation, a suitable pattern material, such as wax, is injected into a suitable pattern die to form a pattern (not shown) of component 80. More specifically, the pattern material is injected into the die around deoxygenated core 310 such that portion 315 extends within the pattern. The pattern is repeatedly dipped into a slurry of mold material 306 which is allowed to harden to create a shell of mold material 306, and the shell is dewaxed to form mold assembly 301. Mold assembly 301 is then fired, that is, subjected to a suitable elevated temperature for a suitable period of time, to strengthen mold 300 and/or remove any remaining traces of pattern material. For example, but not by way of limitation, mold assembly 301 is fired at a suitable temperature in a range of about 870 C (1600 F) to about 1095 C (2000 F) for a suitable duration in a range of about 30 minutes to about 120 minutes.

In some embodiments, an exposure of first material 322 to a suitable mold firing temperature over a suitable mold firing duration substantially increases a rate of oxidation of first material 322. In some such embodiments, because inner wall 321 of hollow structure 320 subsequently defines internal passage 82 of component 80, substantial oxidation of first material 322 along inner wall 321 would decrease a performance of internal passage 82 for its intended purpose. As one example, internal passage 82 is intended to provide a flow of fluid to cool component 80, and oxides of first material 322 formed on inner wall 321 would increase a local surface roughness and, thus, a local turbulence of the flow through internal passage 82, disrupting design heat-transfer characteristics of internal passage 82. However, the substantial absence of oxygen within sealed core chamber 332, as described above, inhibits oxidation of inner wall 321 during the firing process, thus improving an integrity of internal passage 82 as subsequently defined by inner wall 321. In alternative embodiments, mold assembly 301 is formed by any suitable method that enables mold assembly 301 to function as described herein.

In certain embodiments, deoxygenated core 310 is secured relative to mold 300 such that deoxygenated core 310 remains fixed relative to mold 300 during a process of forming component 80. For example, deoxygenated core 310 is secured such that a position of deoxygenated core 310 does not shift during introduction of molten component material 78 into mold cavity 304 surrounding deoxygenated core 310. In some embodiments, deoxygenated core 310 is coupled directly to mold 300. For example, in the exemplary embodiment, a tip portion 312 of deoxygenated core 310 is rigidly encased in a tip portion 314 of mold 300. Additionally or alternatively, a root portion 316 of deoxygenated core 310 is rigidly encased in a root portion 318 of mold 300 opposite tip portion 314. For example, but not by way of limitation, mold 300 is formed by investment casting as described above, and deoxygenated core 310 is securely coupled to the suitable pattern die such that tip portion 312 and/or root portion 316 extend out of the pattern die, while portion 315 extends within a cavity of the die. The pattern material is injected into the die around deoxygenated core 310 such that portion 315 extends within the pattern. The investment casting causes mold 300 to encase tip portion 312 and/or root portion 316. Additionally or alternatively, deoxygenated core 310 is secured relative to mold 300 in any other suitable fashion that enables the position of deoxygenated core 310 relative to mold 300 to remain fixed during a process of forming component 80.

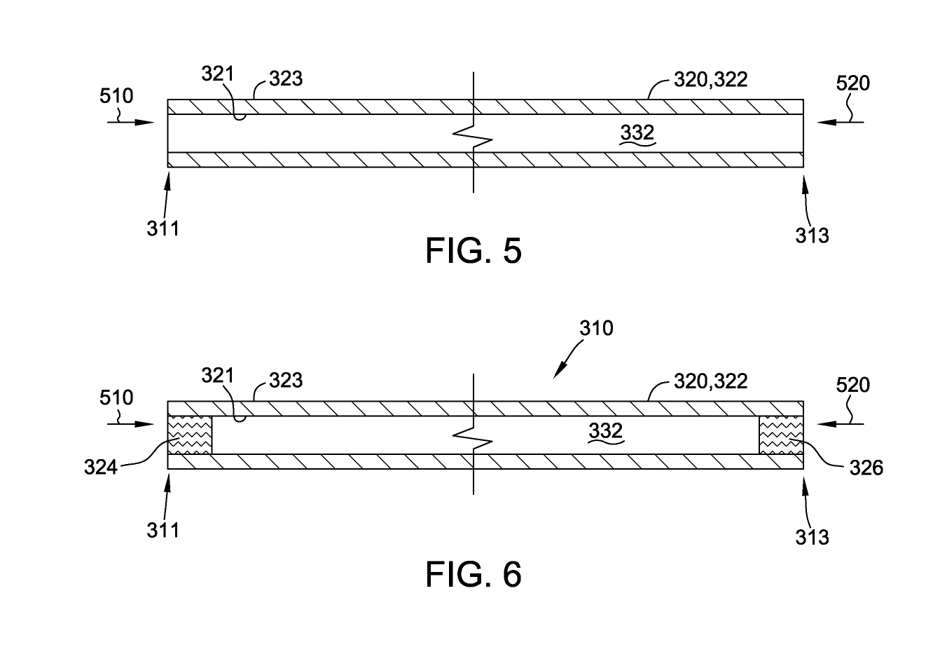

FIGS. 5 and 6 are schematic cross-sections of hollow structure 320 at first and second stages, respectively, during a first exemplary process of forming deoxygenated core 310. In the exemplary embodiment, core chamber 332 is initially filled with ambient air at atmospheric pressure. A first purge flow 510 of an inert gas is initiated at first end 311 of hollow structure 320. For example, the inert gas is at least one of argon, nitrogen, and helium. In some embodiments, first purge flow 510 is within a range of about 4 liters per minute to about 20 liters per minute. In alternative embodiments, first purge flow 510 is any suitable flow rate that enables deoxygenated core 310 to be formed as described herein.

First purge flow 510 is maintained at least until a residual oxygen content of core chamber 332, as measured for example by a suitable sensor, is less than or equal to a suitable threshold level that enables deoxygenated core 310 to function as described herein. For example, the residual oxygen content of core chamber 332 is less than or equal to about 100 ppm. For another example, the residual oxygen content of core chamber 332 is less than or equal to about 50 ppm.

After the threshold level for oxygen content is reached, in the exemplary embodiment, a second purge flow 520 of the inert gas is initiated at second end 313 of hollow structure 320. In some embodiments, second purge flow 520 is about 25 percent of first purge flow 510. In alternative embodiments, second purge flow 520 is any suitable flow rate that enables deoxygenated core 310 to be formed as described herein.

In the exemplary embodiment, after second purge flow 520 is established, first sealing plug 324 is coupled to hollow structure 320 proximate first end 311. For example, but not by way of limitation, first sealing plug 324 is welded to hollow structure 320 proximate first end 311. For another example, but not by way of limitation, first sealing plug 324 is formed by mechanically crimping hollow structure 320 proximate first end 311. In certain embodiments, second purge flow 520 facilitates maintaining the residual oxygen content of core chamber 332 at less than or equal to the selected threshold level during and after formation of first sealing plug 324, which obstructs first purge flow 510. In alternative embodiments, first sealing plug 324 is coupled to hollow structure 320 proximate first end 311 before or during establishment of second purge flow 520. In other alternative embodiments, second purge flow 520 is not used, and first sealing plug 324 is coupled to hollow structure 320 at any suitable time that enables deoxygenated core 310 to be formed as described herein.

In the exemplary embodiment, second purge flow 520 is continued as second sealing plug 326 is coupled to hollow structure 320 proximate second end 313 to seal core chamber 332. For example, but not by way of limitation, second sealing plug 326 is welded to hollow structure 320 proximate second end 313. For another example, but not by way of limitation, second sealing plug 326 is formed by mechanically crimping hollow structure 320 proximate second end 313. In certain embodiments, the relatively low flow rate of second purge flow 520 facilitates avoiding over-pressurization of sealed core chamber 332. In the exemplary embodiment, although a pressure within sealed core chamber 332 increases with temperature during firing of mold assembly 301, sufficient structural strength is provided by first sealing plug 324, second sealing plug 326, and hollow structure 320 to maintain a selected shape of hollow structure 320. After second sealing plug 326 is coupled to inner wall 321, the residual oxygen content of the inert gas within sealed core chamber 332 is less than or equal to the selected threshold level, inhibiting oxidation of first material 322 along inner wall 321, as described above.

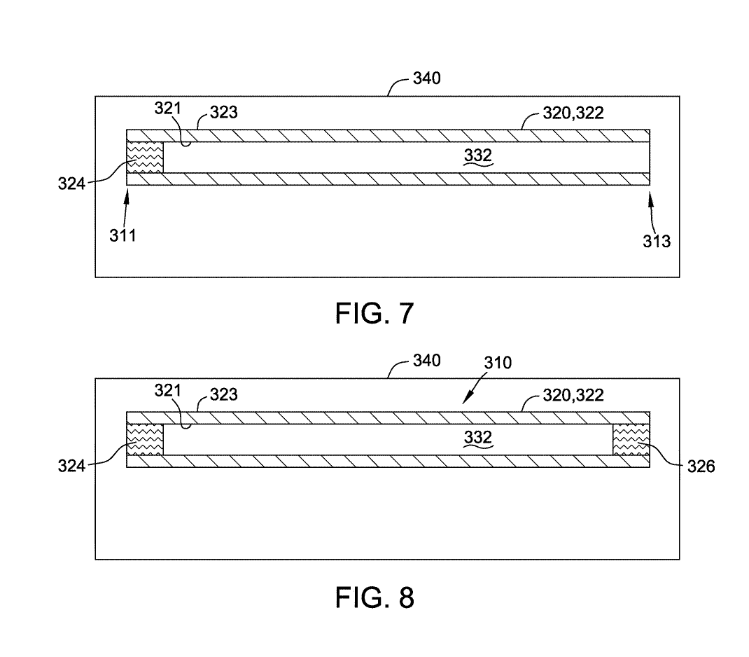

FIGS. 7 and 8 are schematic cross-sections of hollow structure 320 at first and second stages, respectively, during a second exemplary process of forming deoxygenated core 310. In the exemplary embodiment, core chamber 332 is initially filled with ambient air at atmospheric pressure, and first sealing plug 324 is coupled to hollow structure 320 proximate first end 311. For example, but not by way of limitation, first sealing plug 324 is welded to hollow structure 320 proximate first end 311. Hollow structure 320 with first sealing plug 324 coupled thereto is then positioned in a suitable vacuum brazing chamber 340. In alternative embodiments, first sealing plug 324 is coupled to hollow structure 320 within vacuum brazing chamber 340, in a similar fashion to second sealing plug 326 as described below.

For example, vacuum brazing chamber 340 contains air at a vacuum pressure of less than or equal to about 0.076 torr. For another example, vacuum brazing chamber 340 contains air at a vacuum pressure of less than or equal to about 0.00076 torr. For another example, vacuum brazing chamber 340 contains air at a vacuum pressure of less than or equal to about 0.000076 torr. Alternatively, in certain embodiments, vacuum brazing chamber 340 contains at a vacuum pressure, such as but not limited to any of the pressure ranges described above, one of (i) an inert gas, and (ii) a combination of an inert gas and air.

The selected vacuum level of vacuum brazing chamber 340 causes core chamber 332 open at second end 313 to be evacuated to the selected vacuum level. In the exemplary embodiment, second sealing plug 326 is coupled to hollow structure 320 proximate second end 313 by vacuum brazing within vacuum brazing chamber 340 to seal core chamber 332. For example, second sealing plug 326 is formed from a rod of material coupled to inner wall 321 proximate second end 313 using a suitable brazing paste. For another example, second sealing plug 326 is formed using a suitable pre-sintered preform (PSP) formed from a brazing powder and a superalloy powder pre-sintered together and compressed.

After second sealing plug 326 is coupled to hollow structure 320, the low oxygen content within evacuated sealed core chamber 332 subsequently inhibits oxidation of first material 322 along inner wall 321, as described above. Moreover, although a pressure within sealed core chamber 332 increases with temperature during firing of mold assembly 301, the at least partial vacuum initial pressure within sealed core chamber 332 facilitates reducing the maximum pressure within sealed core chamber 332 during firing of mold assembly 301, relative to the use of inert gas at a substantially ambient initial pressure as described in the embodiment of FIGS. 5 and 6. Thus, a strength of a bond between hollow structure 320 and each of first sealing plug 324 and second sealing plug 326 need not be as strong.

With reference again to FIG. 3, in some embodiments, after mold assembly 301 is subjected to the firing process but before mold assembly 301 is subjected to a casting temperature of component 80, first sealing plug 324 is removed from deoxygenated core 310. For example, but not by way of limitation, first end 311 of hollow structure 320, and first sealing plug 324 coupled thereto, is severed from root portion 316. In some such embodiments, removal of first sealing plug 324 facilitates avoiding uncontrolled decoupling of the bond between first sealing plug 324 and hollow structure 320 during casting of component 80. In other embodiments, after mold assembly 301 is subjected to the firing process, mold assembly 301 is then subjected to a casting temperature of component 80, and the casting temperature decouples a bond, such as a welded or brazed bond, between first sealing plug 324 and hollow structure 320, causing first sealing plug 324 to decouple from hollow structure 320.

Similarly, in certain embodiments, after mold assembly 301 is subjected to the firing process but before mold assembly 301 is subjected to a casting temperature of component 80, second sealing plug 326 is removed from deoxygenated core 310. For example, but not by way of limitation, second end 313 of hollow structure 320, and second sealing plug 326 coupled thereto, is severed from tip portion 312. In some such embodiments, removal of second sealing plug 326 facilitates avoiding uncontrolled decoupling of the bond between second sealing plug 326 and hollow structure 320 during casting of component 80. In other embodiments, the casting temperature decouples a bond, such as a welded or brazed bond, between second sealing plug 326 and hollow structure 320, causing second sealing plug 326 to decouple from hollow structure 320.

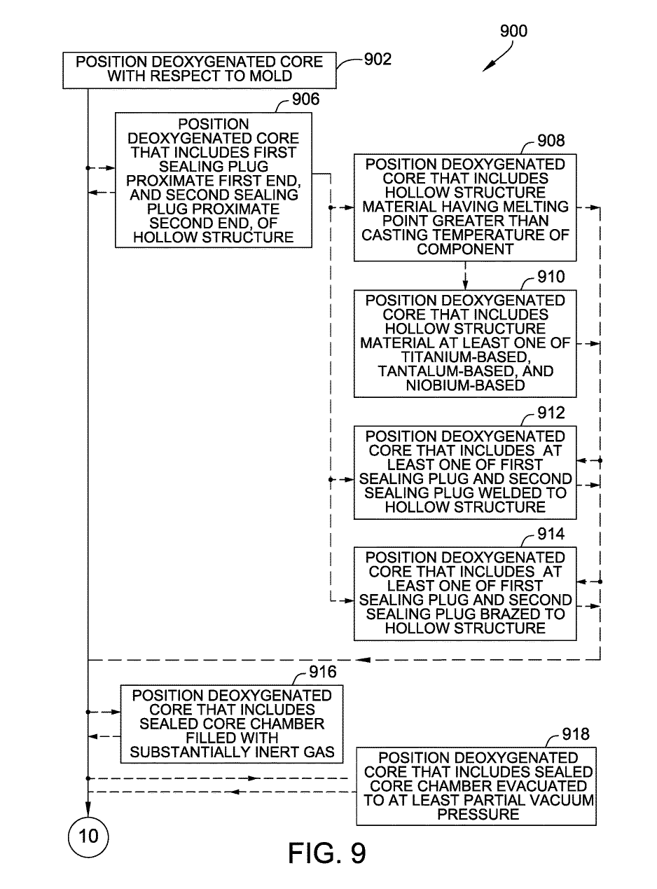

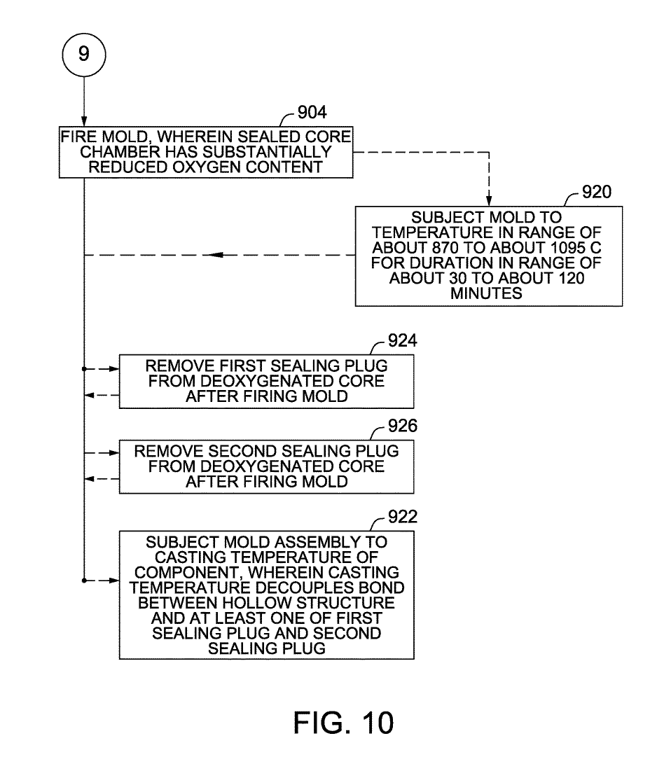

An exemplary method 900 of making a mold assembly, such as mold assembly 301, for forming a component, such as component 80, having an internal passage defined therein, such as internal passage 82, is illustrated in a flow diagram in FIGS. 9 and 10. With reference also to FIGS. 1-8, exemplary method 900 includes positioning 902 a deoxygenated core, such as deoxygenated core 310, with respect to a mold, such as mold 300. The deoxygenated core includes an inner wall, such as inner wall 321, that at least partially defines a sealed core chamber within the deoxygenated core, such as sealed core chamber 332. A portion of the deoxygenated core, such as portion 315, is positioned within a cavity of the mold, such as mold cavity 304, such that the inner wall of the portion of the deoxygenated core defines the internal passage when the component is formed in the mold assembly. Method 900 also includes firing 904 the mold having the deoxygenated core positioned with respect thereto, wherein the sealed core chamber has a substantially reduced oxygen content such that oxidation of the inner wall is inhibited.

In certain embodiments, the step of positioning 902 the deoxygenated core includes positioning 906 the deoxygenated core that further includes a hollow structure, such as hollow structure 320. The hollow structure extends from a first end to a second end, such as first end 311 and second end 313. A first sealing plug, such as first sealing plug 324, is coupled to the hollow structure proximate the first end, and a second sealing plug, such as second sealing plug 326, is coupled to the hollow structure proximate the second end. In some such embodiments, the step of positioning 906 the deoxygenated core includes positioning 908 the deoxygenated core that further includes the hollow structure formed from a first material, such as first material 322, selected to have a melting point greater than a casting temperature of the component. Moreover, in some such embodiments, the step of positioning 908 the deoxygenated core includes positioning 910 the deoxygenated core that further includes the first material being at least one of a titanium-based material, a tantalum-based material, and a niobium-based material.

Additionally or alternatively, the step of positioning 906 the deoxygenated core includes positioning 912 the deoxygenated core that further includes at least one of the first sealing plug and the second sealing plug welded to the hollow structure. Additionally or alternatively, the step of positioning 906 the deoxygenated core includes positioning 914 the deoxygenated core that further includes at least one of the first sealing plug and the second sealing plug brazed to the hollow structure.

In certain embodiments, the step of positioning 902 the deoxygenated core includes positioning 916 the deoxygenated core that further includes the sealed core chamber filled with substantially an inert gas. Additionally or alternatively, the step of positioning 902 the deoxygenated core includes positioning 918 the deoxygenated core that further includes the sealed core chamber evacuated to at least a partial vacuum pressure.

In some embodiments, the step of firing 904 the mold having the deoxygenated core positioned with respect thereto comprises subjecting 920 the mold having the deoxygenated core positioned with respect thereto to a temperature in a range of about 870 C (1600 F) to about 1095 C (2000 F) for a duration in a range of about 30 minutes to about 120 minutes.

In certain embodiments, method 900 further comprises subjecting 922 the mold assembly to a casting temperature of the component. The casting temperature decouples a bond between the hollow structure and at least one of the first sealing plug and the second sealing plug. Additionally or alternatively, method 900 further comprises removing 924 the first sealing plug from the deoxygenated core after firing the mold having the deoxygenated core positioned with respect thereto. Additionally or alternatively, method 900 further comprises removing 926 the second sealing plug from the deoxygenated core after firing the mold having the deoxygenated core positioned with respect thereto.

The above-described deoxygenated core provides a cost-effective method for forming components having internal passages defined therein using a mold assembly, especially but not limited to internal passages having nonlinear and/or complex shapes, thus reducing or eliminating fragility problems and core-removal problems associated with a typical ceramic core. Specifically, the deoxygenated core includes an inner wall that defines the internal passage within the component when the component is formed. A core chamber defined by the inner wall is sealed, and the oxygen content of the sealed core chamber is substantially reduced, during firing of the mold assembly to inhibit oxidation of the inner wall and, thus, preserve a design characteristic of the internal passage. In some embodiments, a hollow structure of the deoxygenated core is formed from a first material selected to facilitate the hollow structure proximate the inner wall remaining intact after molten component material is introduced into the mold cavity around the deoxygenated core. The first material also is selected such that the hollow structure embedded within the component does not prevent the component from meeting performance requirements associated with an intended function of the component.

An exemplary technical effect of the methods, systems, and apparatus described herein includes at least one of: (a) reducing or eliminating fragility problems associated with forming, handling, transport, and/or storage of a ceramic core used in forming a component having an internal passage defined therein; (b) reducing or eliminating core-removal problems associated with a ceramic core used in forming a component having an internal passage defined therein; and (c) enabling formation of longer, thinner, and/or more complex internal passages as compared to passages formed during casting by conventional ceramic cores, and/or as compared to passages formed after casting in subsequent processes, such as electrochemical drilling.

Exemplary embodiments of deoxygenated cores are described above in detail. The deoxygenated cores, and methods and systems using such deoxygenated cores, are not limited to the specific embodiments described herein, but rather, components of systems and/or steps of the methods may be utilized independently and separately from other components and/or steps described herein. For example, the exemplary embodiments can be implemented and utilized in connection with many other applications that are currently configured to use cores within mold assemblies.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A mold assembly for use in forming a component having an internal passage defined therein, said mold assembly comprising:
a mold defining a mold cavity therein; and
a deoxygenated core positioned with respect to said mold, said deoxygenated core comprising an inner wall that at least partially defines a sealed core chamber within said deoxygenated core, wherein:
said sealed core chamber has a substantially reduced oxygen content, and
a portion of said deoxygenated core is positioned within said mold cavity such that said inner wall of said portion of said deoxygenated core defines the internal passage when the component is formed in said mold assembly.

2. The mold assembly of claim 1, wherein said deoxygenated core further comprises a hollow structure that extends from a first end to a second end, a first sealing plug coupled to said hollow structure proximate said first end, and a second sealing plug coupled to said hollow structure proximate said second end.

3. The mold assembly of claim 2, wherein said hollow structure is formed from a first material selected to have a melting point greater than a casting temperature of the component.

4. The mold assembly of claim 3, wherein said first material is at least one of a titanium-based material, a tantalum-based material, and a niobium-based material.

5. The mold assembly of claim 2, wherein at least one of said first sealing plug and said second sealing plug is welded to said hollow structure.

6. The mold assembly of claim 2, wherein at least one of said first sealing plug and said second sealing plug is brazed to said hollow structure.

7. The mold assembly of claim 1, wherein said sealed core chamber is filled with substantially an inert gas.

8. The mold assembly of claim 1, wherein said sealed core chamber is evacuated to at least a partial vacuum pressure.

9. A method of making a mold assembly for forming a component having an internal passage defined therein, said method comprising:
positioning a deoxygenated core with respect to a mold, wherein:
the deoxygenated core includes an inner wall that at least partially defines a sealed core chamber within the deoxygenated core, and
a portion of the deoxygenated core is positioned within a cavity of the mold such that the inner wall of the portion of the deoxygenated core defines the internal passage when the component is formed in the mold assembly; and
firing the mold having the deoxygenated core positioned with respect thereto, wherein the sealed core chamber has a substantially reduced oxygen content such that oxidation of the inner wall is inhibited.

10. The method of claim 9, wherein positioning the deoxygenated core comprises positioning the deoxygenated core that further includes a hollow structure that extends from a first end to a second end, a first sealing plug coupled to the hollow structure proximate the first end, and a second sealing plug coupled to the hollow structure proximate the second end.

11. The method of claim 10, wherein positioning the deoxygenated core further comprises positioning the deoxygenated core that further includes the hollow structure formed from a first material selected to have a melting point greater than a casting temperature of the component.

12. The method of claim 11, wherein positioning the deoxygenated core further comprises positioning the deoxygenated core that includes the first material being at least one of a titanium-based material, a tantalum-based material, and a niobium-based material.

13. The method of claim 10, wherein positioning the deoxygenated core further comprises positioning the deoxygenated core that further includes at least one of the first sealing plug and the second sealing plug welded to the hollow structure.

14. The method of claim 10, wherein positioning the deoxygenated core further comprises positioning the deoxygenated core that further includes at least one of the first sealing plug and the second sealing plug brazed to the hollow structure.

15. The method of claim 9, wherein positioning the deoxygenated core further comprises positioning the deoxygenated core that further includes the sealed core chamber filled with substantially an inert gas.

16. The method of claim 9, wherein positioning the deoxygenated core further comprises positioning the deoxygenated core that further includes the sealed core chamber evacuated to at least a partial vacuum pressure.

17. The method of claim 9, wherein firing the mold having the deoxygenated core positioned with respect thereto comprises subjecting the mold having the deoxygenated core positioned with respect thereto to a temperature in a range of about 870 C (1600 F) to about 1095 C (2000 F) for a duration in a range of about 30 minutes to about 120 minutes.

18. The method of claim 9, further comprising subjecting the mold assembly to a casting temperature of the component, wherein the casting temperature decouples a bond between the hollow structure and at least one of the first sealing plug and the second sealing plug.

19. The method of claim 9, further comprising removing the first sealing plug from the deoxygenated core after firing the mold having the deoxygenated core positioned with respect thereto.

20. The method of claim 9, further comprising removing the second sealing plug from the deoxygenated core after firing the mold having the deoxygenated core positioned with respect thereto.
